(19) United States
(12) Patent Application Publication
(10) Pub. No.: US 2017/0097923 A1
(43) Pub. Date: Apr. 6, 2017

(54) OPEN FIORI APPS OUT OF MS EXCEL

(71) Applicant: SAP SE, Walldorf (DE)

(72) Inventor: Jan Kellmereit, Darmstadt (DE)

(21) Appl. No.: 14/872,848

(22) Filed: Oct. 1, 2015

(51) Int. Cl. G06F 17/24; G06F 17/30

(52) U.S. Cl. CPC G06F 17/246; G06F 17/30371; G06F 17/30377

(57) ABSTRACT

The present disclosure provides methods and systems for transferring data entries in a spreadsheet application to a business application for use and analysis. A user device may send a request for creation of a variant based on selected data within the spreadsheet application. The variant may be created in the backend of a database system and stored for use by a business application. The spreadsheet application may provide a link to a business application for retrieval of the variant data.

### BACKGROUND

In many instances, business applications are hosted on an application server or similar hardware, and operate on data from a database environment. Users may access such business applications from a user device with a client, linked to the application server. Often times, users may wish to transfer data from a spreadsheet application, to the business application for use and analysis.

It would be ideal for the user if he/she could select the objects in the spreadsheet application and directly navigate to the corresponding objects which can be selected in a business application. However, there is currently no technique for allowing multiple objects to be passed from a spreadsheet application to a business application at one time. The user must open the business application and individually enter objects from the spreadsheet application which the user desires to use in the business application and are coming from the database environment backend. Since there could often be a large number of relevant objects in a spreadsheet application, it is not practical to individually transfer each individual object. In addition to consuming a large amount of time, performing such a large number of individual object transfers to the business application would result in performance issues with both the spreadsheet application and the business application.

The inventors perceive a need to navigate from a spreadsheet application to a business application with a set of objects that have been selected in the spreadsheet application with a single transfer.

### BRIEF DESCRIPTION OF THE DRAWINGS

FIG. 1 illustrates a system according to an embodiment of the present disclosure.

FIG. 2 illustrates a view of a spreadsheet application according to an embodiment of the present disclosure.

FIG. 3 illustrates a view of a spreadsheet application according to another embodiment of the present disclosure.

FIG. 4 illustrates a system diagram of a communication protocol.

FIG. 5 illustrates a flow diagram of a method according to an embodiment of the present disclosure.

FIG. 6 illustrates a flow diagram of operation of a communication protocol.

### DETAILED DESCRIPTION

The present disclosure provides methods and systems for making data from an application available for use in a business application. The business application may be part of a suite of business applications hosted via a client. The application may be any application containing data for use in a database environment. By way of non-limiting example, the application may be a word processing, spreadsheet, accounting, presentation, or project management application.

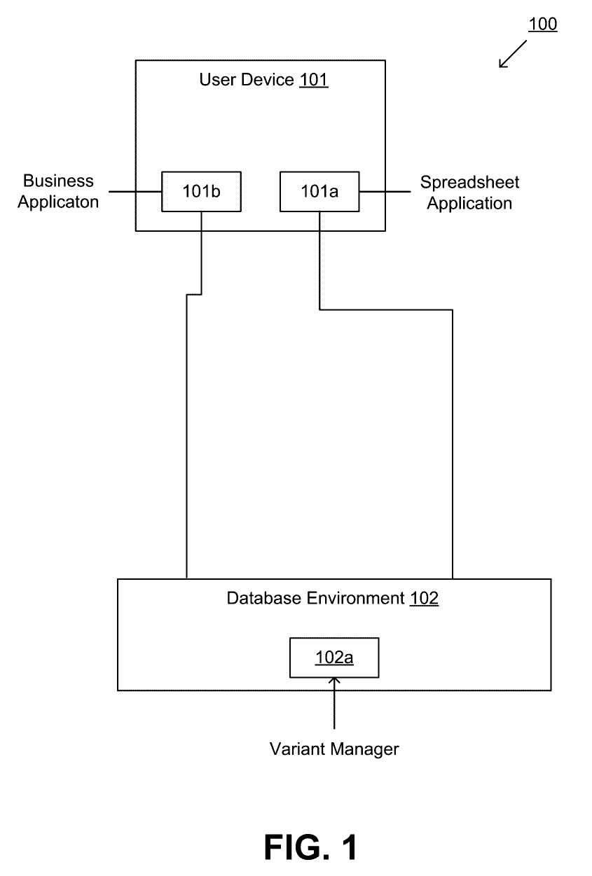

FIG. 1 illustrates a system according an embodiment of the present disclosure. FIG. 1 may include a user device 100 having a spreadsheet application 101a and a business application 101b, and a database environment 102 having a variant manager 102a.

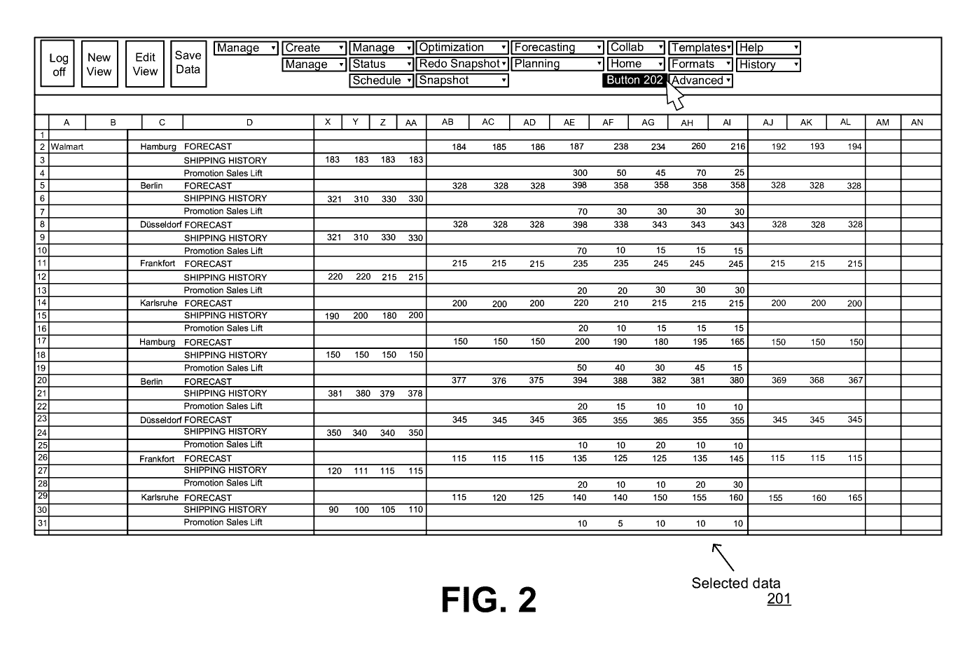

User device 100 may be a laptop computer, tablet computer, or mobile device. However these examples are illustrative only and user device 100 may be any device capable of executing a spreadsheet application and a business application and/or a business application client. User device 100 may include one or more applications having data stored within them. In an embodiment, user device 100 may include a spreadsheet application 101a with data tables containing data that a user wishes to import into a business application that the user is accessing via business application client 101b. Spreadsheet application 101a may contain one or more plug-ins enabling it to send a request (via user device 100) to a backend service of database environment 102 to create a variant based on selected data. The backend service may be a variant manager, such as variant manager 102a. Spreadsheet application 101a may send this request using any suitable communication scheme, such as OData for example (as described more fully herein). FIG. 2 illustrates a spreadsheet application with a plug-in enabling a request for creation of a variant to be sent. In an embodiment, selected data 201 may represent the data that has been pre-selected by a user before sending the request (for example by selecting multiple individual data entries or dragging a cursor over all of the desired data entries). Button 202 may transmit a create request to a backend service of a database environment requesting creation of a variant based on the selected data 201.

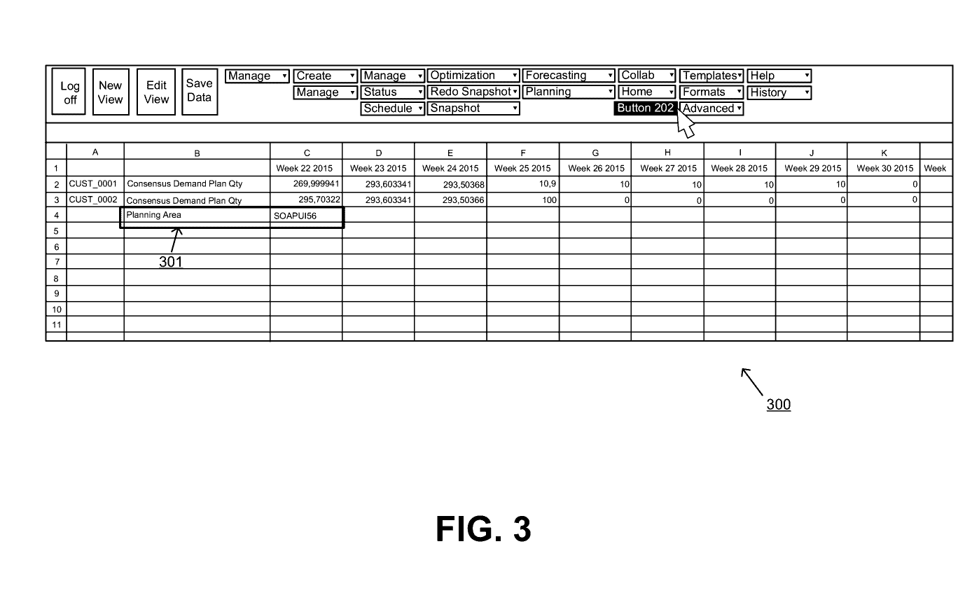

Returning to FIG. 1, prior to requesting creation of a variant, spreadsheet application 101a may check and validate the selected excel data to ensure that all parameters necessary for creation of a variant are present in the selected data prior to transmitting the request. Spreadsheet application 101a may know before-hand which parameters are necessary, and may perform the checking and validation based on these parameters. For example, spreadsheet application 101a may analyze the selected data and determine whether a sufficient number of entries have been selected. If spreadsheet application determines that insufficient entries have been selected, it may display a popup window to the user indicating that not enough values have been selected. In another example, spreadsheet application 101a may check the selected data, to determine whether all the entries in a particular selection are consistent. FIG. 3 illustrates a view of a spreadsheet application having inconsistent data entries selected. The selected data 301 shows that a category “planning area” is selected, however the selected values associated with planning area are not numerical or other data relevant to planning area by week, or customer. The data is merely random text characters. In this case, the spreadsheet application may display a popup window informing the user that the data entries in the selection of data are inconsistent. Returning to FIG. 1, spreadsheet application may check to determine whether the business application which the user desires to transfer data to, the username associated with the business application, and the selected data are all present and consistent with each other. If they are not, spreadsheet application 101a may display a popup to the user, indicating that the selection is not valid for creation of a variant.

If the selected data is valid, spreadsheet application 101a may create an id key containing mandant, business application name and user name data entries. The mandant may represent the uppermost order instance in an IT system and may correspond to data that is a technically and organisationally self-contained unit in the system. The mandant thus represents structured use of the system and makes the key unique. For example, the mandant may be a number from 001 to 999 representing structure of the data. The id key may be used as an identifier for the variant. Spreadsheet application 101a may package the selected data (for example, in a JSON object) along with the key and any other parameter values and transmit them as part of the request for creation of a variant to the database environment 102. Other parameters that may be transmitted as part of the request may include the date/time, language and other similar localization information, and the IP address of the calling web service client among others. In an embodiment, spreadsheet application 101a may transmit the request without a key, and the variant manager 102a within database environment may generate the key and then return the key to spreadsheet application 101a.

Spreadsheet application 101a may use a communication protocol to transmit the create request to database environment 102. The communication protocol may be any web service communication protocol such as HTTPS, OData, or RFC, however these are examples only and user device 100 may use any communication protocol having the ability to request creation of the variant in the backend of the database. In an embodiment, user device 100 may use the OData protocol. In this way, user device 100 may convert the excel data into a common data format, allowing for access to the variant by any OData compatible entity. The OData communication protocol may allow spreadsheet application 101a to transfer data over HTTP using AtomPub, JSON, XML or any other similar means to describe and transfer the data as further described herein.

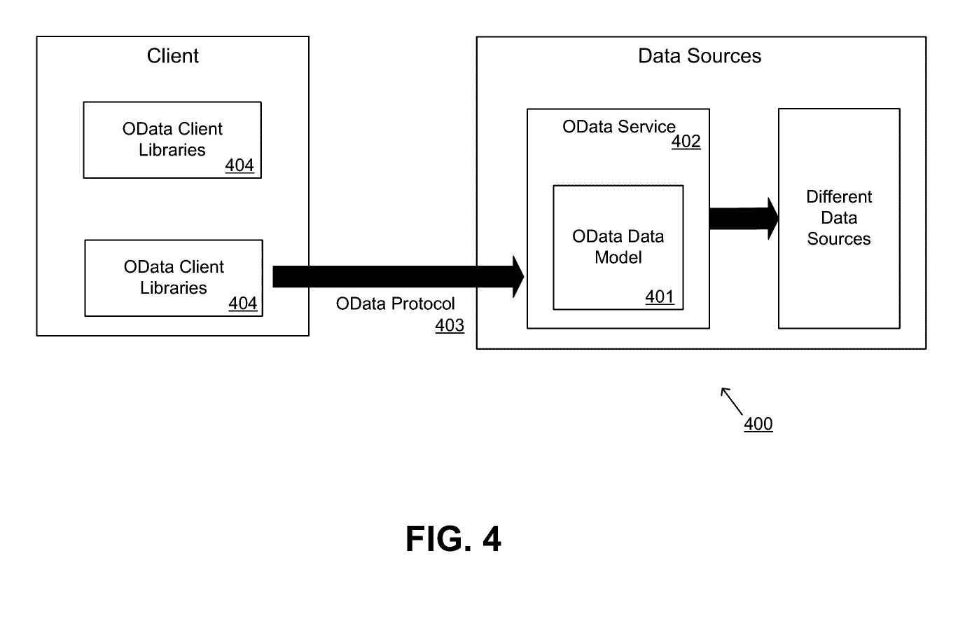

FIG. 4 illustrates a block diagram of an OData communication scheme 400. OData Model 401 may represent data from different data sources in a single format using an abstract data model. In this way, OData may allow any OData compatible client to access information exposed by any OData compatible source.

The OData service 402 may expose data in an OData format for analysis and display by client applications. The OData service may convert the different format of data sources such as SQL relation tables, SharePoint list, and Windows Azure tables into a common format. The OData service 402 may also act as a service layer and expose an endpoint that allows OData compatible clients to access the data using OData Protocol 403 and OData Client library 404. Examples of OData compatible clients may include web browsers, SAPUI5 (business) applications or HTML5 applications. In this manner, any OData client application can access any OData data source.

The OData Protocol 403 may allow a client to make requests to and get responses from an OData service and to access information exposed by any OData source. OData protocol 403 may be a REST (Representational State Transfer) protocol; thus OData may use REST practices which allow various entities to view the data exposed through the OData service 402. For example, the client can be a web browser, or SAPUI5 (business) application or HTML5 application or any other application which supports OData. Any platform that provides support for HTTP and XML is enough to form HTTP requests to interact with an OData service. OData may provide a uniform way to expose, structure, query and manipulate data using REST practices or other well-known web technologies to describe data and transfer data over HTTP such as XML, AtomPub and JSON.

OData may also provide a uniform way to represent metadata about the data, allowing computers to know more about the type system, relationships and structure of the data.

OData Client Libraries 404 may be used by OData client applications to access data from an OData source using OData Protocol. OData Client Libraries may provide pre-built libraries for making OData requests. Examples of OData client libraries available to access OData are: Microsoft .NET Framework 3.51, Java: odata4j, and the OpenUI5 library maintained by SAP.

Returning to FIG. 1, database environment 102 may receive the create request for a variant from user device 100. Database environment 102 may extract the relevant data from the request using the database environment 102's variant manager 102a.

A variant may be a set of input parameters that are defined to view specific sets of data. Upon receiving the create request, variant manager 102a may extract the parameters and data from the create request and define the variant based on the extracted parameters and data. Variant manager 102a may also extract and store the key, thus providing variant manager 102a a means to authenticate future requests for access to the variant. In an embodiment, variant manager 102a may define the key itself. Variant manager 102a may define and store each variant for a particular user. In an embodiment, variant manager 102a may define several variants, and may select one or more from the database environment 102 based on the request from user device 100. In an embodiment, variant manager 102a may enrich the variant with additional information such as user names, calling application id. Other information that the variant manager 102a can enrich the variant with may include the date/time, language and other localization information, and the IP address of calling web service client. In an embodiment, the variant manager 102a may perform an authorization check to determine if the user is allowed to see the data which will be requested later on by the variant data.

In an embodiment, variant manager 102a may perform an additional check of the input parameters to ensure their consistency and that all necessary input parameters are present before creating and storing of the variant.

Upon creation of the variant, spreadsheet application 101a may generate a URL link containing the key. The OData communication protocol may provide an entire query language directly in a URL, thus allowing spreadsheet application 101a to transmit the variant id as a URL parameter to the business application 101b. Spreadsheet application 101a may use the OData communication protocol to define and transmit the URL to the business application 101b.

Upon receiving the URL with the variant id, a business application may read the URL and determine the key from the URL. This may be done using any conventional technique. Upon determining the key, the business application may send a request containing the key to the database environment to retrieve the variant from database environment 102. Business application 101b may communicate with the database environment 102 using the OData communication scheme.

Upon receiving the request at database environment 102, variant manager 102a may compare the key included in the request, and the key stored at creation of the variant. If the key values do not match up, variant manager 102a may deny access to the variant. If the key values are a match, variant manager 102a may grant access to the variant and send the variant to the business application. For example, the business application may receive the variant and add the data to the business application's filter bar for use.

Business application 101b may then send a delete request to the database environment 102 to delete the variant.

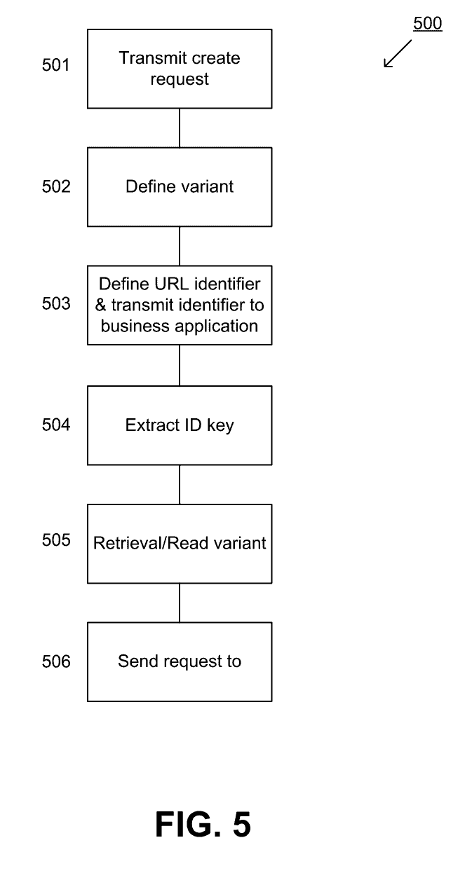

FIG. 5 illustrates a method 500 according to an embodiment of the present disclosure.

At box 501, method 500 may send a request to create a variant based on selected data in a spreadsheet application. In an embodiment, method 500 may check and validate the selected excel data to ensure that all parameters necessary for creation of a variant are present in the selected data. Method 500 may know before-hand which parameters are necessary, and may perform the checking and validation based on these parameters. For example, method 500 may analyze the selected data and determine whether a sufficient number of entries have been selected. If method 500 determines that insufficient entries have been selected, it may display a popup window to the user indicating that not enough values have been selected. In another example, method 500 may check the planning area, to determine whether all the entries in a particular section have been selected. If not, method 500 may display a popup window informing the user that there are unselected entries in a section of data. By way of example only, method 500 may check to determine whether the business application which the user desires to transfer data to, the username associated with the business application, and the selected data are all present and consistent with each other. If they are not, method 500 may display a popup to the user, indicating that the selection is not valid for creation of a variant. If the selected data is valid, method 500 may use the spreadsheet application to create a key containing the mandant, business application name and user name data entries. Method 500 may use the key as an identifier for the variant. Method 500 may package the data (in a JSON object, for example) along with the key and any other parameter values and transmit them to a database environment as part of the request for creation of a variant. Other parameters that method 500 may include in the request for creation are the date/time, language and other localization information, and the IP address of the calling web service client. Method 500 may use a communication protocol to transmit the create request to database environment 102. The communication protocol may be any web service communication protocol such as HTTPS, OData, or RFC, however these are examples only and method 500 may use any communication protocol having the ability to communicate with and request creation of a variant from the backend of a database environment. In an embodiment, method 500 may use the OData protocol. OData may allow Method 500 to transmit the request over HTTP using AtomPub, XML, JSON, or any other similar means to describe and transfer the data as described more fully herein. In an embodiment, method 500 may transmit the request without a key, and may generate the key at the database environment.

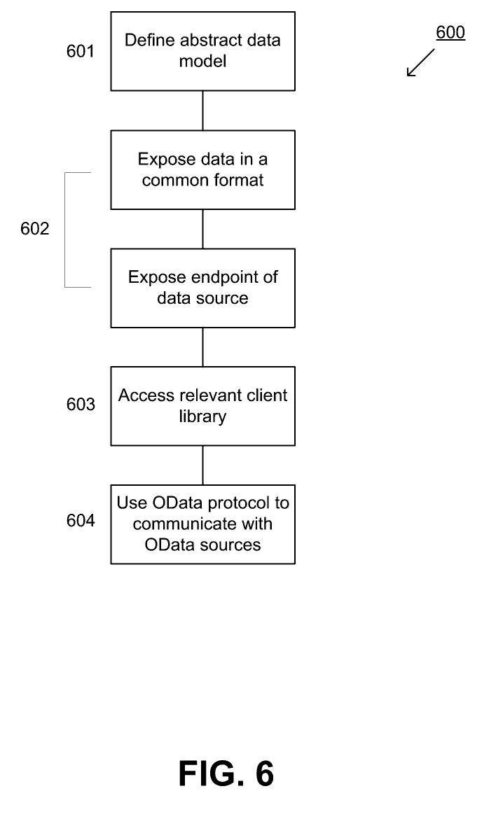

FIG. 6 illustrates a flow diagram of an OData communication scheme 600. At box 601, the OData communication scheme 600 may represent data from different data sources in a single format using an abstract data model. In this way, OData communication scheme 600 may allow any OData compatible client to access information exposed by any OData compatible source.

At box 602, the OData communication scheme 600 may use the OData service to expose the data from a source in an OData format for analysis and display by client applications. The OData service may convert the different format of data sources such as SQL relation tables, SharePoint list, and Windows Azure tables into a common format. The above data sources are examples only and are not meant to be limiting. The OData service may also act as a service layer and expose an endpoint of a data source that allows clients to access the data using OData Protocol and OData Client library. Examples of OData compatible clients include web browsers, SAPUI5 (business) applications or HTML5 applications, as well as any other application which supports OData. In this manner, any OData compatible client application can access any OData compatible data source.

At box 603, the OData communication scheme may use OData Client Libraries to access data from an OData compatible source using OData Protocol. OData Client Libraries may provide pre-built libraries for making OData requests. Examples of OData client libraries available to access OData are: Microsoft .NET Framework 3.51, Java: odata4j, and the OpenUI5 library maintained by SAP.

At box 604, the OData communication scheme 600 may use the OData protocol to allow a client to make requests to and get responses from a service and to access information exposed by any OData source. OData protocol may be a REST (Representational State Transfer) protocol; thus OData may use REST practices to allow various entities to view the data exposed through the OData service. For example, the client may be a web browser, or SAPUI5 (business) application or HTML5 application or any other application which supports OData. Any platform that provides support for HTTP and XML is enough to form HTTP requests to interact with an OData service. OData may provide a uniform way to expose, structure, query and manipulate data using REST practices to describe data and transmit data via HTTP using well known web technologies like HTTP, XML, AtomPub and JSON.

The OData communication scheme may also provide a uniform way to represent metadata about the data, allowing computers to know more about the type system, relationships and structure of the data.

Returning to FIG. 5, at box 502, method 500 may receive the create request for a variant from the user device and define a variant. For example, method 500 may receive the request at a database environment. Method 500 may extract the relevant data from the request using a variant manager.

A variant may be a set of input parameters that are defined to view specific sets of data. Upon receiving the create request, method 500 may extract the parameters and data from the request and define the variant based on the extracted parameters and data. For example, method 500 may specify the path and name for the OData service to the calculation view or the BI query that is the origin of the data the variant is based on. Method 500 may also extract and store the key, thus providing the variant manager a means to authenticate future requests for access to the variant. In an embodiment, method 500 may receive a request not containing a key and define a key using the variant manager. Method 500 may define and store each variant for a particular user. In an embodiment, method 500 may define and store several variants within the database environment, and may select one or more from the database environment based on the request from the user device. In an embodiment, method 500 may enrich the variant with additional information such as user names, calling application id,

In an embodiment, method 500 may perform an additional check of the input parameters to ensure their consistency and that all necessary input parameters are present before creating and saving of the variant.

At box 503, method 500 may generate a URL link containing the key upon creation of the variant. Method 500 may utilize the spreadsheet application to generate the URL. The OData communication protocol may provide an entire query language directly in a URL, thus allowing method 500 to define and transmit the variant id as a URL parameter via the OData communication protocol to the particular business applications requiring the data.

At box 504, upon receiving the URL with the variant id at a business application, method 500 may read the URL and determine the key from the URL. This may be done using any conventional technique. Upon determining the key, method 500 may transmit a request containing the key to the database environment to retrieve the variant from the database environment.

At box 505, upon receiving the request at the database environment, method 500 may compare the key included in the request, and the key stored at creation of the variant. If the key values do not match up, method 500 may deny access to the variant. If the key values are a match, method 500 may grant access to the variant and transmit the variant data to the business application. Method 500 may receive the variant data at the business application and add the data to the business application for use. For example, method 500 may add the data to the business application's filter bar for use.

Method 500 may then send a delete request to the database environment to delete the variant.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

We claim:

1. A method comprising:
transmitting a request based on a set of selected data from an application, the request comprising a set of parameters;
defining a variant based on the transmitted set of parameters and storing the variant in the database environment;
transmitting a link corresponding to the variant to a business application;
retrieving the variant data using the link;
sending a delete command to delete the variant from the database environment.

2. The method of claim 1, wherein the transmitting is done using a communication protocol.

3. The method of claim 2, wherein the set of parameters comprises the selected data, and an id key corresponding to the variant, the id key also being stored.

4. The method of claim 2, wherein the set of parameters comprises the selected data and further comprising defining and storing an id key corresponding to the variant.

5. The method of claim 2, wherein the communication protocol is an OData protocol.

6. The method of claim 2, wherein the communication protocol is one of an RFC or an HTTPS protocol.

7. The method of claim 3, further comprising modifying the link to include the id key prior to transmission, and ensuring that the id key from the link and the id key stored match before allowing retrieval of the variant data.

8. The method of claim 1, further comprising checking the set of selected data for consistency prior to transmitting the request.

9. The method of claim 1, wherein the transmitting of the request and the link are accomplished by a plug in.

10. A method comprising:
transmitting a request to create a variant based on a set of selected data from an application, the request comprising a set of parameters;
transmitting a link corresponding to the variant to a business application;
retrieving the variant data using the link.

11. A system, comprising:
a user device configured to:
transmit a request to create a variant based on a set of selected data from an application, the request containing a set of parameters,
in response to creation of the variant, define and transmit a link corresponding to the variant to a business application,
retrieve the variant data using the link,
send a delete command to delete the variant;
a database environment, configured to define a variant based on the set of parameters and store the variant.

12. The system of claim 10, wherein the transmitting is done using a communication protocol.

13. The system of claim 12, wherein the set of parameters comprises the selected data and an id key corresponding to the variant, and the database environment is further configured to also store the id key.

14. The system of claim 12, wherein the set of parameters comprises the selected data and the database environment is further configured to define and store an id key corresponding to the variant.

15. The system of claim 12, wherein the communication protocol is an OData protocol.

16. The system of claim 12, wherein the communication protocol is one of an RFC or HTTPS protocol.

17. The system of claim 13, wherein to define the link, the user device is further configured to include the id key in the link, and where database environment is further configured to ensure that the id key from the URL and the stored id key match before allowing retrieval of the variant data.

18. The system of claim 11, wherein the user device is further configured to check the set of selected data for consistency prior to transmitting the request.

19. The system of claim 11, wherein the transmitting of the request and the link are accomplished by a plug in.

20. The system of claim 11, wherein the spreadsheet application is MS Excel.

21. A machine readable storage medium having stored thereon a computer program comprising instructions for causing the machine to:
transmit a request based on a set of selected data from an application, the request comprising a set of parameters;
define, within a database environment, a variant based on the transmitted set of parameters and storing the variant in the database environment;
transmit a link corresponding to the variant to a business application;
retrieve the variant data using the link;
send a delete command to delete the variant from the database environment.
